(19) United States
(12) Patent Application Publication
(10) Pub. No.: US 2024/0428112 A1
(43) Pub. Date: Dec. 26, 2024

(54) SYSTEMS AND METHODS FOR QUANTUM MONTE CARLO PROCESSING

(71) Applicant: HSBC SOFTWARE DEVELOPMENT (GUANGDONG) LIMITED, Guangzhou (CN)

(72) Inventors: Bing Zhu, Shanghai (CN); Ziyuan Li, Guangzhou (CN); Yong Xia, Shanghai (CN); Mianmian Zhang, Guangzhou (CN); Si Yuan Jin, Hong Kong (CN); Kar Yan Tam, Hong Kong (CN); Yuhan Huang, Hong Kong (CN); Oiming Shao, Hong Kong (CN)

(73) Assignee: HSBC SOFTWARE DEVELOPMENT (GUANGDONG) LIMITED, Guangzhou (CN)

(21) Appl. No.: 18/404,169

(22) Filed: Jan. 4, 2024

(51) Int. Cl. G06N 10/60; G06N 10/40

(52) U.S. Cl. CPC G06N 10/60; G06N 10/40

(57) ABSTRACT

The invention relates generally to systems and methods estimating a target outcome using a combination of quantum computing and a Monte Carlo simulation. A quantum processor loads variables and distributions into a quantum system, begins a quantum walk, performs arithmetic operations with the variables and distributions to initiate the steps in the quantum walk, and ultimately performs a quantum estimation of the quantum state to estimate a target variable.

### FIELD OF THE DISCLOSURE

The present disclosure relates generally to the field of quantum computing and more particularly to a software-based implementation of Quantum Monte Carlo methods.

### BACKGROUND

Quantum computing employs quantum-mechanical phenomena to store and manipulate information, distinguishing itself from classical computing models. It has been applied to address complex simulation and optimization problems. However, practical implementation of quantum computing in commercial settings often requires specialized expertise and circuit design techniques, creating high barriers to entry for business researchers and practitioners. This application addresses this challenge by examining the potential of quantum computing in Monte Carlo simulations, an area of interest for business practitioners.

### SUMMARY OF THE DISCLOSURE

In some aspects, the techniques described herein relate to a system including: a quantum processor; and a memory including instructions stored thereon, which, when executed by the quantum processor causes the system to perform operations including: loading one or more variables and one or more probability distributions to a quantum system; initiating a quantum walk on the one or more variables and probability distributions, wherein the quantum walk includes one or more predetermined steps, wherein each predetermined step is associated with a quantum arithmetic operation on the one or more variables and probability distributions; and determining, upon a last quantum arithmetic operation, a target variable by estimating a quantum state of the quantum system.

In some aspects, the techniques described herein relate to a method for estimating a target outcome, the method including: loading, by a quantum processor, one or more variables and one or more probability distributions into a quantum system; initiating, by the quantum processor, a quantum walk on the one or more variables and probability distributions, wherein the quantum walk includes one or more predetermined steps, wherein each predetermined step is associated with a quantum arithmetic operation on the one or more variables and probability distributions; and determining, upon a last quantum arithmetic operation, a target variable by estimating a quantum state of the quantum system.

In some aspects, the techniques described herein relate to a non-transitory computer readable medium containing computer executable instructions that, when executed by a computer hardware arrangement, cause the computer hardware arrangement to perform procedures including: loading, by a quantum processor, one or more variables and one or more probability distributions into a quantum system; initiating, by the quantum processor, a quantum walk on the one or more variables and distributions, wherein the quantum walk includes one or more predetermined stepfs, wherein each predetermined step is associated with a quantum arithmetic operation on the one or more variables and probability distributions; and determining, upon a last quantum arithmetic operation, a target variable by estimating a quantum state of the quantum system.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments of the invention.

FIG. 1 is a block diagram illustrating a system according to example embodiments.

FIG. 2 is a flowchart illustrating a method according to example embodiments.

FIG. 3 is a diagram illustrating a method according to example embodiments.

FIG. 4 block diagram illustrating a method according to example embodiments.

FIGS. 5A-5C are charts illustrating different relationship between error rate, samples, and estimated values according to example embodiments.

FIG. 6 is a block diagram illustrating a system according to example embodiments.

### DETAILED DESCRIPTION

Quantum computing is a novel paradigm that uses quantum-mechanical phenomena to store and manipulate information, unlike classical computing models. It has shown promise in solving complex simulation and optimization problems that are relevant for business applications. However, quantum computing also poses significant challenges for business researchers and practitioners, such as the need for specialized expertise and circuit design techniques.

The business literature has documented the increasing use of quantum to tackle practical business challenges. Quantum uncertainties have been investigated in the context of human decision-making and extended to business decision-making. Quantum-inspired optimization methods have been employed to accelerate business-related computational problems, while semidefinite programs have emerged as central topics in quantum information science. A quantum subroutine has also been proposed to expedite the simplex method. Despite these advancements, the potential of quantum Monte Carlo simulations to aid business researchers and practitioners still needs to be explored.

There are numerous improvements to quantum computing technology when leveraging Monte Carlo methods. For example, Monte Carlo methods often excel at handling statistical and probabilistic aspects of problems. When Monte Carlo methods are applied to quantum walks, this combination leads to improvements in data sampling and error mitigation, especially when compared to conventional quantum walks, which are often inaccessibly complicated. Additionally, Monte Carlo techniques may also improve quantum walks by incorporating Monte Carlo randomness, which results in greater noise resilience. Overall, the combination of quantum computing and Monte Carlo methods can harness the strengths of both paradigms for more effective quantum walk models.

One or more techniques disclosed herein improve upon conventional processes by incorporating quantum computing and Monte Carlo simulations. For example, one or more techniques disclosed herein provide a quantum state-based or distribution-based paradigm for computation referred to herein as “FinQMC.” FinQMC may include one or more components: distribution loading, quantum variables, quantum arithmetic, quantum walk, and quantum estimation. Distribution loading allows the system to sample from various distributions for Monte Carlo simulations. By combining these components, FinQMC can tackle various problems such as financial problems that are usually solved by classical Monte Carlo methods. Additionally, FinQMC is specifically designed to enable business practitioners to use quantum Monte Carlo techniques without requiring in-depth knowledge of quantum computing or circuit design. It provides enhanced accuracy and accelerated results compared to conventional methods. The framework's generalization capability equips business practitioners to adapt to shifting market conditions and address novel financial challenges readily. The advantages of this framework for business practitioners are numerous, including a robust foundation for future developments in universal quantum computing, a user-friendly instrument, improved accuracy and expedited results, and generalization capabilities. In conclusion, the following embodiments present a considerable opportunity for businesses to capitalize on the potential of quantum computing in efficiently and effectively resolving complex financial issues.

### Quantum Mechanics Background:

The field of quantum computing can be divided into two categories: quantum annealing and universal quantum computing. While quantum annealing has been used to solve quadratic unconstrained binary optimization problems, it has a limited problem-solving scope and heuristic-based speed-up. However, universal quantum computing provides a mathematically rigorous speed-up compared to classical algorithms and enables the development of algorithms for more problems.

As the fundamental unit of quantum information, the qubit operates in a binary format (0 and 1) to encode data. Within the framework of quantum mechanics, the quantum state serves as a mathematical representation of a system, facilitating the storage and manipulation of information, including probability distributions. In quantum computing, a qubit can exist in a superposition state, which is a linear combination of basis states given by the amplitudes α₀ and α₁:

$$\vert s 〉 ( {α}_{0} \vert 0 〉 + {α}_{1} \vert 1 〉$$

wherein the probabilities of obtaining states 0 and 1 are determined |α₀|² and |α₁|², respectively. Therefore, the sum of |α₀|² and |α₁|² is 1. Upon measurement, the initially indeterminate superposition state collapses into a single outcome with distinct probabilities. For instance, if a qubit is measured and determined to be 1, subsequent measurements will consistently yield 1, thus enabling experimental validation. Although measurement collapses a superposition state into a single outcome, the super-position principle can be preserved and harnessed for calculations until the desired result is obtained, thereby facilitating complex computations.

### Quantum Distribution:

To load a probability distribution Pr(x) onto a quantum state the following expression can be used:

$$\vert ψ 〉 = {\sum }_{i = 0}^{{2}^{n} - 1} \sqrt{Pr ( {s}_{i} )} \vert {s}_{i} 〉$$

where, |sᵢ [symbol] represents that quantum state and n is the number of utilized qubits. Measuring this state produces a sample |sᵢ [symbol] from the probability distribution.

### Quantum Arithmetic:

Quantum states can execute simple logic and arithmetic operations. For example, two superposition states |ψₐ [symbol] and |ψ_{b} [symbol] can be added together. In addition, quantum states can also perform more complex operations such as multiplication, division, and exponentiation. These operations can be implemented using quantum circuits or quantum algorithms in various ways.

### Applications:

The present embodiments enable efficient representation and sampling of probability distributions Pr(x) using quantum states, approximating continuous data distributions as discrete distributions by selecting representative data points:

$$\vert ψ 〉 = {\sum }_{i = 0}^{{2}^{n} - 1} \sqrt{Pr ( {s}_{i} )} \vert {s}_{i} 〉$$

wherein |sᵢ [symbol] is the i-th quantum state, n is the number of qubits, Pr(x) is the probability distribution, and |ψ [symbol] is the quantum state.

In some embodiments, this approach allows practitioners to represent financial variables using quantum superposition states without requiring knowledge of quantum mechanics. Although data loading is often challenging in practical quantum computing, the systems and methods described herein may rely on loading distribution only for Monte Carlo scenarios, which can be achieved efficiently using several previously proposed methods.

In some embodiments, the present system can use quantum states to represent probability distributions and perform discrete time-step sampling through quantum walks. This technique may involve adding two variables or superposition states in their respective bases, resulting in a superposition state with an exponential number of potential sums, which may enable financial data representation and manipulation. Thus, the present framework may enhance traditional Monte Carlo methods by exploiting quantum computing properties to represent the sampling space. For example, a 100-qubit state in quantum computing can represent a 2¹⁰⁰ sampling space, which is a formidable challenge for classical computers.

Additionally, these systems and methods use quantum states to represent probability distributions and perform discrete time-step sampling through quantum walks. This technique may rely on loading the distribution only once and using quantum arithmetic for quantum walk simulation. The process begins by loading the distribution at different time steps, with each line representing a register. They view each register as a variable for subsequent computations and refine the variable through quantum arithmetic before using quantum estimation to determine expectation or minimum value. The larger sample space of quantum information and the faster convergence rate of quantum algorithms enable complex financial variable computation, such as without limitation the market price of risk and return.

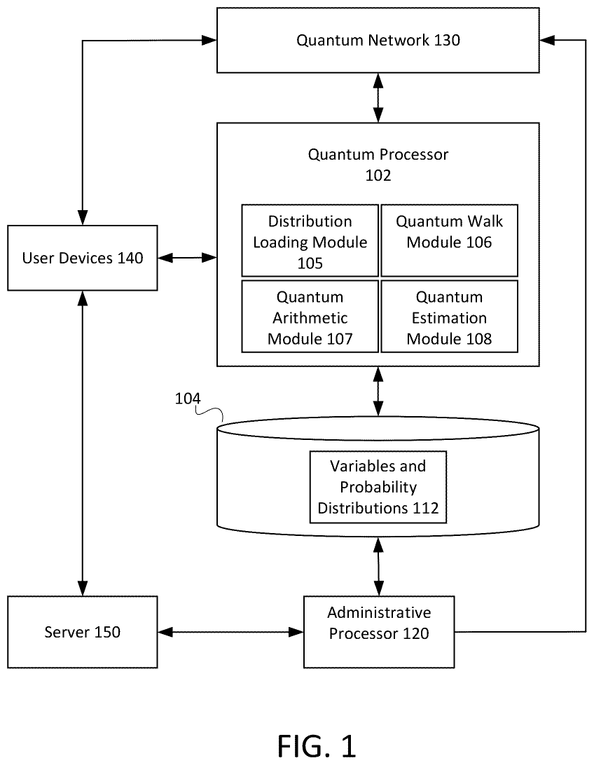

FIG. 1 is a block diagram illustrating a system 100 according to example embodiments. The system 100 may include a quantum processor 102, a database or data storage unit 104, an administrator processor 120, a server 150, one or more user devices 140, and a quantum network 130. The quantum processor 102 can include any number of modules including a distribution loading module 105, a quantum walk module 106, a quantum arithmetic module 107, and a quantum estimation module 108. The modules may be collections of code or instructions stored on a media that represent a series of machine instructions that implement one or more actions explained below. Each of these modules can be stored within a memory or data storage unit associated with the quantum processor 102. Any of the actions performed by the quantum processor 102 may also be performed by the server 150 assuming that the server 150 has quantum computing capabilities.

In example embodiments, a user device 140 or administrator processor 120 can initiate a quantum walk by transmitting a request to the quantum processor 102 requesting a quantum walk for a certain target variable. In some embodiments, the target variable may be a high-return stock portfolio or vehicle sales in the coming year. The user device 140 and administrator processor 120 may be computer-enabled devices connected to the quantum processor 102 via the quantum network 130. The quantum processor 102 may receive this request and via the distribution loading module 105 load one or more variable or probability distributions into the system. The distribution loading module 105 may instruct the quantum processor 102 to retrieve the variables and probability distributions 112 from the database or data storage unit 104. The variables and probability distributions 112 may be chosen by the user via the user device 140 or administrator processor 120. In some embodiments, the user device 140, administrator processor 120, or server 150 can retrieve the variables and probability distributions 112 and transmit them to the quantum processor 102 over the quantum network 130. In some embodiments, the distribution loading module 105 can also define the number of qubits for each variable and distribution. The probability distributions can include any number of relevant statistical or numerical significance, including without limitation normal distributions, log-normal distributions, and constant distributions. Other variable and distributions may include one or more sizes of the distributions, means of the distributions, or bounds of the distributions. The quantum processor 102 may be connected to the database or data storage unit 104 via a wired or wireless connection. In example embodiments, the administrator processor 120 itself or the user device 140 itself may retrieve and transmit the variables and probability distributions 112. In still other example embodiments, the quantum processor can adjust one or more of the quantum variables and probability distributions of the walk based on the intermediate results of the quantum arithmetic. For example, at the fifth step of the quantum walk, the quantum processor can adjust one of the variables or probability distributions in order to meet some criteria set by the user, such as hitting a minimum or maximum value.

Having loaded the variables and probability distributions, the quantum processor 102 via the quantum walk module 106 can conduct the quantum walk to estimate the target variable. Once the quantum walk has begun, the quantum processor 102 via the quantum arithmetic module 107 can perform one or more quantum arithmetic operations on the quantum walk.

More generally, instead of a classical walker with a well-defined position, in a quantum walk, the walker is represented by a quantum state which describes the quantum information of system which may include of one or more qubits. The quantum state may be represented as a vector in a complex vector space. The quantum state may encode the probabilities of measuring the system in various quantum states. The quantum walker may explore multiple paths simultaneously. In some embodiments, the walks can involve multiple directions of movement, unlike classical random walks that typically move in only one direction. At the beginning of the walk, the walker may be represented by a quantum state. Quantum operations (as explained in step 210 below) may be applied to the quantum state. These operations determine the walker's evolution and ultimately determine the quantum estimation of the target variable. In some example embodiments, the quantum estimation can be made after the last quantum arithmetic operation is done. In other embodiments, the quantum estimation can be made at other points in the quantum walk, such as after the first step, second step, fifth step, tenth step, and so on.

The framework uses random walks as a key component of its Monte Carlo algorithm. Random walks involve sampling and arithmetic operations. Unlike previous approaches that used random walks on a grid for search, in example embodiments the framework focuses on simulating financial instruments over time using quantum superposition states.

Each operation performed during the quantum walk may result in another quantum “step” or some change in the quantum state of the system. The operations can include addition, subtraction, multiplication, or any other quantum arithmetic operation. Each operation may change the quantum state to some degree. Once the user determines that no further quantum arithmetic is required, the quantum walk has ended, and the quantum state can be estimated. The quantum processor 102 via the quantum estimation module 108 can estimate the quantum state. Estimating the quantum state may effectively estimate the target variable. For example, the quantum processor 102 may estimate that the expected total vehicle sales for next year is 20,000 vehicles. As another nonlimiting example, the quantum processor 102 may estimate the most lucrative stock portfolio is composed of x percent of Stock 1 and y percent of Stock 2.

In some embodiments, the result of quantum estimation may be expressed in binary form. As those skilled in the art understand, an increased number of qubits provides greater precision. Nevertheless, to conserve limited quantum resources, a minimum number of qubits can be used. For instance, if the estimated value is 70, seven qubits can be used to represent values up to 2⁷-1=127, resulting in the θₓ_{ₜ} of

$$\frac{70}{127} * \frac{π}{2} .$$

However, additional ancillary qubits can represent the value, resulting in a reduced amplitude for faster convergence. By incorporating three ancillary qubits, values up to 2¹⁰-1=1023 with the θₓ_{ₜ} of

$$\frac{70}{1023} * \frac{π}{2}$$

can be represented. A smaller amplitude value leads to a quicker convergence rate.

Once the quantum processor 102 estimates the quantum state, the quantum processor 102 can transmit the estimation to either or both the user device 140 and the administrator processor 120 over the quantum network 130. In some embodiments, the quantum processor 102 can receive one or more additional variables or probability distributions from the user device 140. In such instances, the quantum processor 102 can pause or redo the quantum walk to include the new variables. The quantum processor 102 can also provide a confidence interval for the estimated target variable. For example, the quantum processor 102 may find that target variable is a value x within a confidence interval of 10%.

In example embodiments, the quantum processor 102 may store the one or more variables and probability distributions 112 in a database both before and after converting them into qubits. Any number of the previous steps in FIG. 1 can be repeated.

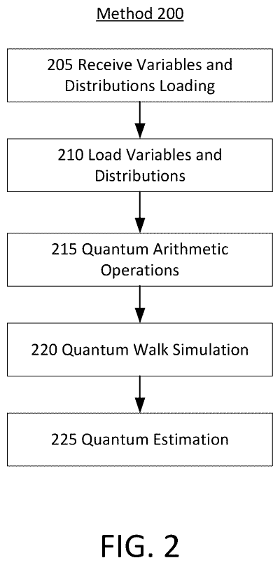

FIG. 2 is a flowchart illustrating a method 200 of a process according to exemplary embodiments.

Generally, the method 200 may be aimed at estimating one or more target values. The target value (or more simply the target) may refer to a metric or variable to be measured or predicted. For example, the target value may be predicted sales of a certain vehicle in the coming year. To estimate the total sales (i.e., to estimate the target value), the quantum processor can convert one or more variables and probability distributions in qubits, perform a quantum walk by arithmetically combining the variables in quantum space, then estimate the resulting quantum state. The quantum state describes the state of the system and ultimately it measures the target variable.

At step 205, the quantum processor may receive one or more variables and distributions. In some embodiments, quantum processor may receive the one or more variables and/or distributions from one or more of a user device, administrator processor, the quantum processor itself, or server including one or more cloud servers. T

At step 210, the quantum processor can load or transmit the one or more variables and distributions into one or more memories associated with the quantum processor. In some embodiments, the variables and distributions may have already been loaded onto a data storage unit or database, in which case the quantum processor can query or retrieve the variables and distribution from the data storage unit. Examples of variables and distributions can include without limitation: probability distributions that have been estimated beforehand such as uniform distributions, normal distributions, binomial distributions, and log-normal distributions. The quantum processor can load new and updated variables and distributions one or more times at the beginning and throughout the method 200. For instance, new or updated distributions may be loaded part-way through the method 200.

In some embodiments, the actions of defining variables and loading distributions can be accomplished through following procedures via Python script:

```
  Input: int: nᵥ, n_{d}, μ, σ; str: name, distribution; tuple: bound.
    1. Initialize var = Variable (nᵥ, name).
    2. Load distribution for var by var.load_distribution( distribution, n_{d}, μ, σ, bound).
  Output: A variable with distribution loaded.
where int, str, tuple is data type, referring integer, string, and tuple (store two items in a single
variable). nᵥ defines the number of qubits for representing the variable, and n_{d} defines the
distribution size. μ is the mean of the distribution. σ is the standard error of the distribution.
Distribution may refer to the distribution name chosen. Bound may refer to the left and right bound
of the distribution.
```

In some embodiments, the quantum processor may perform additional steps after receiving and loading the variables and quantum distributions. As a nonlimiting example, upon loading the variables and distributions the quantum processor can also initialize the quantum state, including the initializing of a quantum state that represents the probability distributions that may be estimated. This quantum state could be a superposition of states, each representing a possible outcome with corresponding probabilities. In some embodiments, suppose that the distribution is a uniform distribution from 1 to N, where N is a positive integer.

In some embodiments, the quantum processor can perform additional steps before performing quantum arithmetic. As a nonlimiting example, upon loading the variables and distributions the quantum processor can map the variables and probability distributions into the quantum domain. That is, the variables and distributions that are represented in classical context must be mapped into a form that can be processed by the quantum processor. In the quantum domain, information is typically encoded as quantum states which are represented as vectors in a complex vector space. Thus, the quantum processor can encode each of the variables and distributions as quantum states.

At step 215, the quantum processor may perform one or more operations on the one or more variables and distributions. These operations can include any operations between two or more qubits, including without limitation addition, subtraction, division, and multiplication. The framework may offer a variety of quantum arithmetic operations, such as addition, multiplication, squaring, exponentiation, Max/Min operations, and threshold operations. In some embodiments, these operations may be based on a Fourier transform technique that enables efficient computation of complex arithmetic tasks. The quantum processor can apply these operations to any variable object, which represents a complex financial variable. The framework has a modular design that allows for easy integration of additional operations, therefore a person of skill in the art that other embodiments may use other operations not explicitly reference herein. The framework may provide users significant flexibility for manipulating complex financial variables.

In some embodiments, the arithmetic operation can proceed as follows:

```
  Input: Variable: var₁, var₂; str: operation;
    1: Initialize FinQMC qmc.
    2: Add two variables into the framework by qmc.add_variable(var).
    3: Perform arithmetic operations by qmc.arithmetic(operation, [var₁, var₂])
  Output: A arithmetic operation is performed on two variables.
where Variable refers to the data structure from the previous action. str refers to string data
structure. var₁ and var₂ are two variables, operation means which arithmetic operation to choose.
```

In some embodiments, the quantum processor can perform quantum arithmetic operations to perform a weighted sum of the possible outcomes.

At step 220, the quantum processor may perform one or more quantum walks or quantum walk simulations on the variables and distributions. The quantum walk can be a Monte Carlo walk, also known as a random walk or a stochastic walk, each of which refers to a mathematical and computational concept that describes a sequence of steps or movements taken by a particle or system in a random or probabilistic manner. The walk may include a number of steps taken by the quantum processor. The number of steps may be predetermined or dynamic depending on the target variable. For example, it may be specified that the quantum walk have a predetermined number of twelve steps. At each step, the quantum processor may make a random move or decision based on a probability distribution gathered or received at step 205. In some embodiments, the randomness of the move or decision can be simulated using one or more techniques, such as, without limitation, a random number generator. The walk proceeds in a sequential manner, with each step being dependent on the outcome of the previous step. In example embodiments, the quantum processor can adjust one or more of the quantum variables and probability distributions of the walk based on the intermediate results of the quantum arithmetic. For example, at the fifth step of the quantum walk, the quantum processor can adjust one of the variables or probability distributions in order to meet some criteria set by the user, such as hitting a minimum or maximum value.

The framework ensures the accuracy of its quantum walk implementation by distinguishing between the parameters of nᵥ and n_{d} in the distribution action. By ensuring that (n_{d}+j=nᵥ), the quantum walk uses an extra qubit to avoid overflow while adding the steps. This technique allows the framework to track the quantum walk's progress accurately and use it effectively in its Monte Carlo simulations.

In some embodiments, the quantum Monte Carlo walk can proceed as follows:

```
  Input: int: nₛ, n_{d}, μ, σ; str: name, distribution; tuple: bound.
    1: for j + 1to nₛ do
    2: Generate Variable with nᵥ of j + n_{d}.
    3: Load distribution with distribution (distribution, μ, σ, bound).
    4: end for
    5: Use arithmetic operations to accumulate different variables.
  Output: A set of random walk operations are performed on the circuit.
where nₛ is the number of steps, n_{d} is the number of qubits for the distribution in loading step, and
nᵥ is the number of qubits for the variable. Other parameters are the same as the previous two
actions.
```

At step 225, the quantum processor may perform a quantum estimation. In some example embodiments, the quantum estimation can be made after the final quantum arithmetic operation is done. In other embodiments, the quantum estimation can be made at other points in the quantum walk, such as after the first step, second step, fifth step, tenth step, and so on. The framework may use quantum amplitude estimation (QAE) as a method for evaluating the amplitude of a quantum state. The method may exploit the quantum mechanics principle that the amplitude of a desired state, such as the minimum value, can be amplified while reducing the amplitude of undesired states. Then, by measuring the state with optimized amplitudes, the framework can obtain the desired result.

To evaluate the expected quantum amplitude, information may be loaded from state to amplitude. In some embodiments, an extra ancilla qubit may be used for efficiently creating an operator that performs the following:

$$\vert {X}_{t} 〉 \vert 0 〉 -> \vert {X}_{t} 〉 ( cos [ {θ}_{{X}_{t}} ] \vert 0 〉 + sin [ {θ}_{{X}_{t}} ] \vert 1 〉 )$$

where cos[θₓ_{ₜ}] is the amplitude of state |0 [symbol] , and sin[θₓ_{ₜ}] is the amplitude of state |1 [symbol] . θₓ_{ₜ} equals to

$$\frac{{X}_{t}}{{2}^{{n}_{v}}} * \frac{π}{2}$$

and nᵥ means the number of qubits used to represent the final result information. To improve precision, as many qubits as possible may be used. Quantum Amplitude Estimation can be used to get E[θₓ_{ₜ}] efficiently.

In some embodiments, the quantum Monte Carlo walk can proceed as follows:

```
  Input: Variable: var; int: ϵ, α;
    1. Directly estimate the expectation value of var with confidence level α and target
      precision ϵ.
  Output: Expectation Value of Variable var.
where integer α refers to confidence level and ϵ refers to target precision. Any number of the
previous steps in FIG. 2 can be repeated.
```

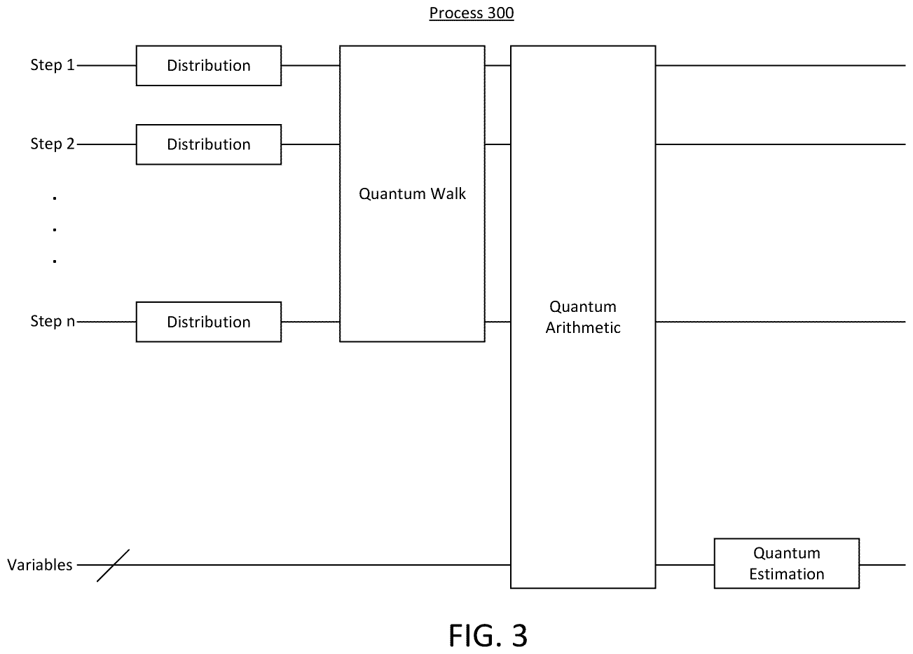

FIG. 3 is a block diagram illustrating implementation of a Quantum Monte Carlo (QMC) circuit, according to example embodiments. Each line may represent a variable that includes multiple qubits. The process may begin by loading the step register with the distribution, followed by accumulating each step to initiate the quantum walks. Subsequently, quantum arithmetic operations are performed to refine and obtain the desired financial variables. Finally, the quantum estimation module is utilized to compute the target variable.

Unlike classical Monte Carlo simulations requiring multiple samples, the present approach loads the distribution once and utilizes quantum arithmetic for quantum walk simulation. The process may start by loading the distribution at different time steps, with each line representing a register. Viewing each register as a variable for subsequent computations, one can refine the variable through quantum arithmetic before employing quantum estimation to ascertain expectation or minimum value. Referring to the model, in Step 1 the distribution and the first variable are loaded into the first time-step (i.e., the first “step” of the quantum walk), and thus the quantum walk begins. Likewise, in Step 2 the distribution and the second variable are loaded into the second time step, and thus the quantum walk takes it second step, and quantum arithmetic refines the variables as each variable is added with each time step. Quantum information's larger sample space and quantum algorithms' faster convergence rate enable complex financial variable computation, such as the market price of risk and return. In still other example embodiments, the quantum processor can adjust one or more of the quantum variables and probability distributions of the walk based on the intermediate results of the quantum arithmetic. For example, at the fifth step of the quantum walk, the quantum processor can adjust one of the variables or probability distributions in order to meet some criteria set by the user, such as hitting a minimum or maximum value.

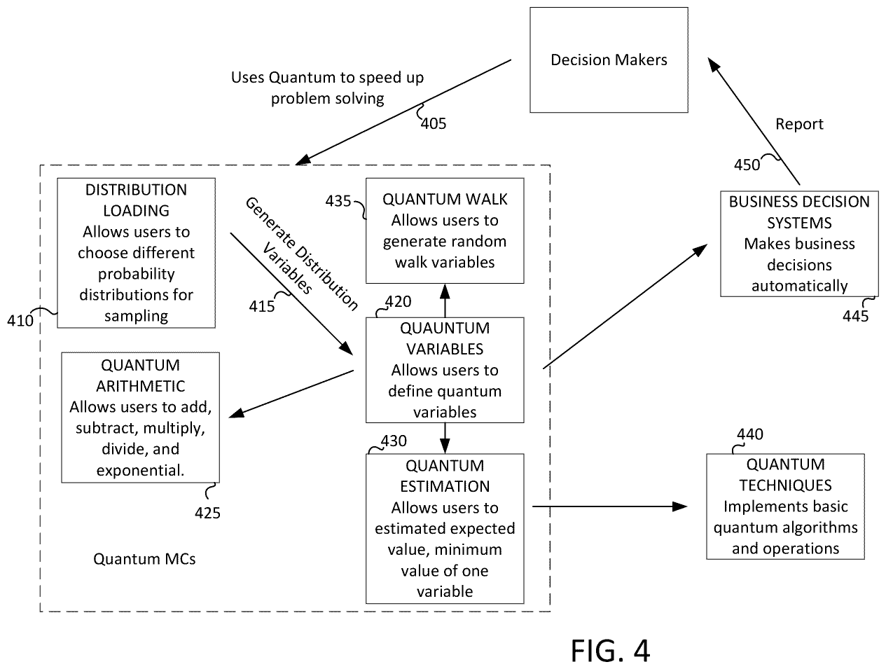

FIG. 4 illustrates the modular structure of the Quantum Monte Carlo (FinQMC) framework, according to example embodiments. The framework may include four modules: a quantum variable module, a quantum arithmetic module, a quantum walk module, and a quantum estimation module. The quantum arithmetic module may be configured to define quantum variables and assign either constant or distribution-based values, the ‘Quantum Arithmetic’ module, which provides efficient operations between any two variables, the ‘Quantum Walk’ module, which streamlines the sampling and accumulation process, and the ‘Quantum Estimation’ module, which calculates expected values or minimum values within a distribution. The modules may be collections of code or instructions stored on a media that represent a series of machine instructions that implement one or more actions explained below. Each of these modules can be stored within a memory or data storage unit associated with the quantum processor.

As illustrated in FIG. 4, decision makers in action 405 can decide to use quantum computing to speed up problem solving or estimate a target value. Once the decision makers have decided on a target value, the process proceeds with the distribution loading step in action 410 in which a quantum processor receives different probability distributions for sampling in the ensuing quantum estimation from one or more user devices and administrative processor associated with, e.g., decision makers. For example, if the target value is estimated car sales, the quantum processor may receive select probability distributions related to past sales, consumer behavior trends, overall consumer spending, infrastructure spending, etc. As another nonlimiting example, if the target value is an optimal investment portfolio, the quantum processor may receive select probability distributions related to past investments, past performance of mutual funds, federal interest rates, and other economic indicators. Having generated any number of variables and distribution probabilities in action 415, the quantum processor may receive the quantum variables for estimating the target value in step 420. In step 420, the quantum processor may receive quantum variables for estimating the target, or the variables and distributions that will actually be used in the quantum computing step. The quantum processor can map their selected variables and distributions (which are likely expressed in classical computing terms) onto a quantum state. With the quantum variables defined, the process then proceeds to the quantum arithmetic module and quantum walk module. In action 435, the quantum state (i.e., the state of the quantum system) can be affected and changed by adding the quantum variables and distributions. In the quantum arithmetic step in action 425, the multiple quantum variables are combined arithmetically through quantum operations, effectively combining the variables through addition, multiplication, exponentiation, or some other arithmetic operation. As these operations are made, the quantum state changes, until ultimately the quantum state is ready to be estimated in the quantum estimation step in which the quantum processor can estimate the expected value of the target, such as the minimum of one or more of the selected variables. Having estimated the quantum state in action 430, the quantum processor can generate a call API to request other or separate quantum techniques to implement basic quantum algorithms and operations in action 440. Additionally, once the quantum estimations have been made, the quantum processor can transmit the results to a business decision system such as the administrator processor or user device in action 445, at which point the business decisions can be returned to the decision makers in action 450. Actions 445 and 450 can be performed over a wired or wireless network. The business decision system can store the data long-term in a database or data storage unit.

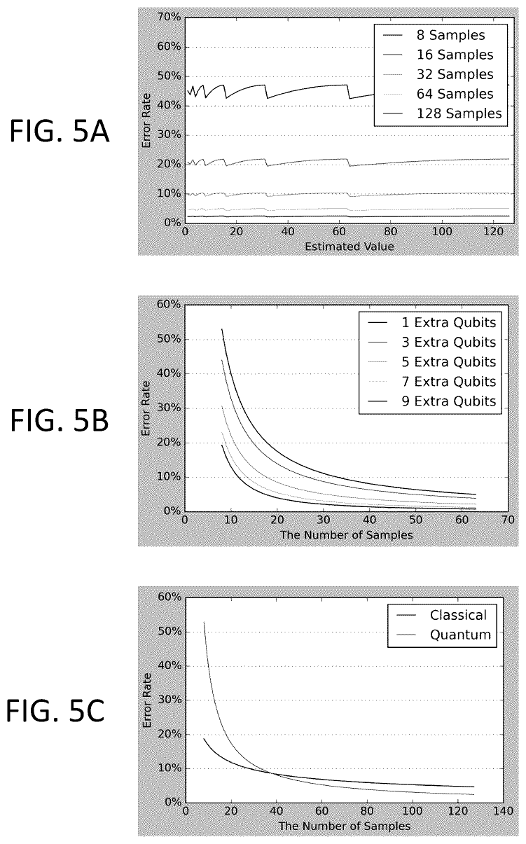

FIGS. 5A and 5B illustrate the error rate of quantum estimations. The y-axis depicts the maximum error rate, computed based on the probability of

$$\frac{8}{{π}^{2}} .$$

On the left side, the x-axis represents the target value to be estimated. The figure demonstrates the relationship between the error rate and the number of samples. On the right side, the x-axis illustrates the number of samples. The figure showcases the relationship between the error rate and the number of additional qubits (ancilla qubits). FIG. 5A illustrates how the error rate is lower for quantum estimations that use higher numbers of samples, e.g., the error rate for an estimation that used 128 samples is lower than an estimation that used 64 samples. FIG. 5B illustrates how the error rate is lower for quantum estimations that both (or either) use a higher number of samples and/or use extra qubits. For example, a quantum estimation that uses about 30 samples would have a lower error rate if it also utilized 7 extra qubits instead of 3 extra qubits.

FIG. 5C illustrates the convergence rate of a classical Monte Carlo simulation versus a Quantum Monte Carlo simulation as described in the systems and methods. The average convergence rate between classical Monte Carlo and Quantum Monte Carlo reveals a faster convergence rate for Quantum Monte Carlo than classical methods. For example, FIG. 5C reveals that once 40 or more samples are used, the Quantum Monte Carlo simulations begins to have a lower error rate than the classical Monte Carlo.

### Application of FinQMC: Portfolio Selection

In some embodiments, the FinQMC or quantum Monte Carlo method can be used to select portfolios. For example, one or more techniques disclosed herein may extend quantum computing functionality to the process of selecting a portfolio related to investing.

In classical portfolio selection, the Malliavin derivative method involves simulating state variables and Malliavin derivatives and computing expectations. The Monte Carlo covariation method approximates the optimal portfolio based on the covariation between wealth and Brownian motions. However, convergence using classical Monte Carlo is often slow. Hence, the following embodiments aim to develop a quantum version of their approach. Business practitioners can still follow their classical workflow to solve the same problem.

Portfolio selection entails selecting a set of investments to maximize return given risk or minimize risk given a return. A common challenge in real-world applications is time-varying factors, which need a closed-form solution and require Monte Carlo simulation. In a binomial model, a portfolio with n assets can have 2n possible outcomes, resulting in an exponentially costly computational expense. The quantum Monte Carlo framework discussed above addresses the complexity of portfolio selection by efficiently representing the sampling space and utilizing quantum algorithms. In this framework, the embodiments simulate each step of the Monte Carlo paths, rather than directly loading the final-time data, to incorporate multiple market factors into one's portfolio selection decisions.

In portfolio selection, normal distributions may be allocated to various time steps and then aggregate these steps. These embodiments simulate the 2ⁿ−1 paths of the Brownian Motion process, denoted as W. Each path is divided into T discrete steps spanning the time interval from 0 to T. To simulate a Monte Carlo path with T time steps using quantum computing, a state |ψ_{T} [symbol] with T registers may be created, each representing an independent random variable:

$$\vert {ψ}_{T} 〉 = \vert {dW}_{0} 〉 \vert {dW}_{1} 〉 ... \vert {dW}_{t} 〉 ... \vert {dW}_{T} 〉$$

where |dWₜ [symbol] is a state in a register representing the change in the Brownian motion process at time t:

$$\vert {dW}_{t} 〉 = {\sum }_{i = 0}^{{2}^{n} - 1} \sqrt{{p}_{t}} \vert {z}_{t} 〉$$

and pₜ is the probability of obtaining |zₜ [symbol] by measurement.

Then apply the addition operator to obtain a new state |ψ_{T} [symbol] representing the sum of independent motion changes at each time step:

$$\vert {{ψ}^{′}}_{T} 〉 = \vert {dW}_{0} 〉 \vert {dW}_{0} + {dW}_{1} 〉 ... \vert {\sum }_{i = 0}^{t} {dW}_{i} 〉 ... \vert {\sum }_{i = 0}^{T} {dW}_{i} 〉$$

Using this approach, different superposition states for financial variables such as risk r and discount factor ξ can be obtained. These quantum states include different states entangled; for example, θₜ is influenced θₜ₋₁. These states can be represented as:

$$\vert {{θ}^{′}}_{T} 〉 = \vert {θ}_{0} 〉 \vert {θ}_{1} 〉 ... \vert {θ}_{t} 〉 ... \vert {θ}_{T} 〉$$

$$\vert {{r}^{′}}_{T} 〉 = \vert {r}_{0} 〉 \vert {r}_{1} 〉 ... \vert {r}_{t} 〉 ... \vert {r}_{T} 〉$$

$$\vert {{ξ}^{′}}_{T} 〉 = \vert {ξ}_{0} 〉 \vert {ξ}_{1} 〉 ... \vert {ξ}_{t} 〉 ... \vert {ξ}_{T} 〉$$

Since addition operators are used among superposition states, they would not influence the algorithm's complexity, even providing exponential speed-up. X_{T} can be computed with all these states depending on the utility function:

$$\vert {X}_{T} 〉 = \vert \frac{{X}_{t}}{{ξ}_{t , T}} 〉$$

where the initial time point t=0.

Using the expected value of |X_{T} [symbol] , the constant y* can be obtained. This constant can then be used to compute |X_{t+Δt} [symbol] =|y*X_{Tξ}_{ₜ}_{+Δt,T} [symbol] .

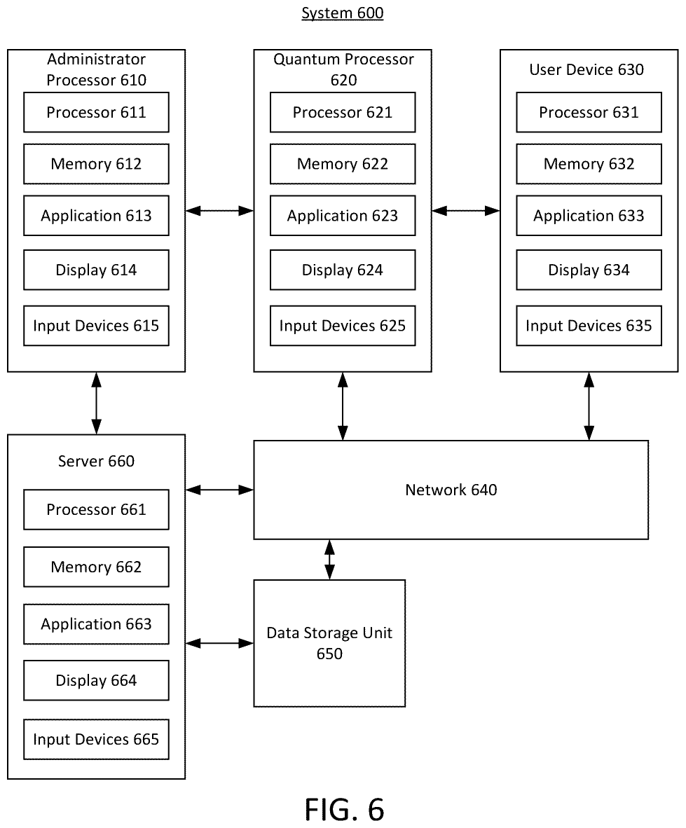

FIG. 6 illustrates a system 600 according to an example embodiment. The system 600 may include an administrator processor 610, a quantum processor 620, a user device 630, a network 640, database or data storage unit 650, and a server 660. Although FIG. 1 illustrates single instances of components of system 100, system 100 may include any number of components.

The administrator processor 610 may include a processor 611, a memory 612, and an application 613. The processor 611 may be a processor, a microprocessor, or other processor, and the administrator processor 610 may include one or more of these processors. The processor 611 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 611 may be coupled to the memory 612. The memory 612 may be a read-only memory, write-once read-multiple memory or read/write memory, e.g., RAM, ROM, and EEPROM, and the administrator processor 610 may include one or more of these memories. A read-only memory may be factory programmable as read-only or one-time programmable. One-time programmability provides the opportunity to write once then read many times. A write-once read-multiple memory may be programmed at one point in time. Once the memory is programmed, it may not be rewritten, but it may be read many times. A read/write memory may be programmed and re-programed many times after leaving the factory. It may also be read many times. The memory 612 may be configured to store one or more software applications, such as the application 613, and other data, such as user's private data and financial account information.

The application 613 may include one or more software applications, such as a mobile application and a web browser, which may include instructions for execution on the administrator processor 610. In some examples, the administrator processor 610 may execute one or more applications, such as software applications, that enable, for example, network communications with one or more components of the system 600, transmit and/or receive data, and perform the functions described herein. Upon execution by the processor 611, the application 613 may provide the functions described in this specification, specifically to execute and perform the steps and functions in the process flows described below. Such processes may be implemented in software, such as software modules, for execution by computers or other machines. The application 613 may provide graphical user interfaces (GUIs) through which a user may view and interact with other components and devices within the system 600. The GUIs may be formatted, for example, as web pages in HyperText Markup Language (HTML), Extensible Markup Language (XML) or in any other suitable form for presentation on a display device depending upon applications used by users to interact with the system 600.

The administrator processor 610 may be configured to interface with one or more of a display 614 or input devices 615. The display 614 may be any type of device for presenting visual information such as a computer monitor, a flat panel display, and a mobile device screen, including liquid crystal displays, light-emitting diode displays, plasma panels, and cathode ray tube displays. The input devices 615 may include any device for entering information into the administrator processor 610 that is available and supported by the administrator processor 610, such as a touchscreen, keyboard, mouse, cursor-control device, touchscreen, microphone, digital camera, video recorder or camcorder. These devices may be used to enter information and interact with the software and other devices described herein.

The system can include one or more quantum processors 620. The quantum processor 620 may include a processor 621, a memory 622, and an application 623. The processor 621 may be a processor, a microprocessor, or other processor, and the quantum processor 620 may include one or more of these processors. The processor 621 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein. Furthermore, the quantum processor 621 can include one or more quantum gates, which are the quantum analogs of classical logic gates, and a qubit register, which is the quantum equivalent of a classical bit register. The quantum gates apply quantum operations to qubits, inducing quantum entanglement, superposition, and interference. The qubit register stores and manipulates qubits, and it can be in a superposition of multiple states, enabling parallel processing. The quantum processor 620 may include other specialized hardware such as superconducting qubit devices, trapped-ion systems, or other quantum technologies.

The processor 621 may be coupled to the memory 622. The memory 622 may be a read-only memory, write-once read-multiple memory or read/write memory, e.g., RAM, ROM, and EEPROM, and the quantum processors 620 may include one or more of these memories. A read-only memory may be factory programmable as read-only or one-time programmable. One-time programmability provides the opportunity to write once then read many times. A write-once read-multiple memory may be programmed at one point in time. Once the memory is programmed, it may not be rewritten, but it may be read many times. A read/write memory may be programmed and re-programed many times after leaving the factory. It may also be read many times. The memory 622 may be configured to store one or more software applications, such as the application 623, and other data, such as user's private data and financial account information. Furthermore, the quantum processor 620 is configured to have quantum bits or qubits of memory that can exist in superpositions of 0 and 1. Both classical memories and quantum memories may be present in the quantum processor 620.

The application 623 may include one or more software applications, such as a mobile application and a web browser, which may include instructions for execution on the quantum processor 620. In some examples, the quantum processor 620 may execute one or more applications, such as software applications, that enable, for example, network communications with one or more components of the system 600, transmit and/or receive data, and perform the functions described herein. Upon execution by the processor 621, the application 623 may provide the functions described in this specification, specifically to execute and perform the steps and functions in the process flows described below. Such processes may be implemented in software, such as software modules, for execution by computers or other machines. The application 623 may provide graphical user interfaces (GUIs) through which a user may view and interact with other components and devices within the system 600. The GUIs may be formatted, for example, as web pages in HyperText Markup Language (HTML), Extensible Markup Language (XML) or in any other suitable form for presentation on a display device depending upon applications used by users to interact with the system 600.

The quantum processor 620 may be associated with one or more of a display 624 or input devices 625. The display 624 may be any type of device for presenting visual information such as a computer monitor, a flat panel display, and a mobile device screen, including liquid crystal displays, light-emitting diode displays, plasma panels, and cathode ray tube displays. The input devices 625 may include any device for entering information into the quantum processor 620 that is available and supported by the quantum processor 620, such as a touchscreen, keyboard, mouse, cursor-control device, touchscreen, microphone, digital camera, video recorder or camcorder. These devices may be used to enter information and interact with the software and other devices described herein.

The system 600 can include one or more user devices 630. The user device 630 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The user device 630 may include a processor 631, a memory 632, and an application 633. The processor 631 may be a processor, a microprocessor, or other processor, and the user device 630 may include one or more of these processors. The processor 631 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 631 may be coupled to the memory 632. The memory 632 may be a read-only memory, write-once read-multiple memory or read/write memory, e.g., RAM, ROM, and EEPROM, and the user device 630 may include one or more of these memories. A read-only memory may be factory programmable as read-only or one-time programmable. One-time programmability provides the opportunity to write once then read many times. A write-once read-multiple memory may be programmed at one point in time. Once the memory is programmed, it may not be rewritten, but it may be read many times. A read/write memory may be programmed and re-programed many times after leaving the factory. It may also be read many times. The memory 632 may be configured to store one or more software applications, such as the application 633, and other data, such as user's private data and financial account information.

The application 633 may include one or more software applications, such as a mobile application and a web browser, including instructions for execution on the user device 630. In some examples, the user device 630 may execute one or more applications, such as software applications, that enable, for example, network communications with one or more components of the system 600, transmit and/or receive data, and perform the functions described herein. Upon execution by the processor 631, the application 633 may provide the functions described in this specification, specifically to execute and perform the steps and functions in the process flows described below. Such processes may be implemented in software, such as software modules, for execution by computers or other machines. The application 633 may provide graphical user interfaces (GUIs) through which a user may view and interact with other components and devices within the system 600. The GUIs may be formatted, for example, as web pages in HyperText Markup Language (HTML), Extensible Markup Language (XML) or in any other suitable form for presentation on a display device depending upon applications used by users to interact with the system 600.

The user device 630 may be associated with one or more of a display 664 or input devices 635. The display 634 may be any type of device for presenting visual information such as a computer monitor, a flat panel display, and a mobile device screen, including liquid crystal displays, light-emitting diode displays, plasma panels, and cathode ray tube displays. The input devices 635 may include any device for entering information into the user device 630 that is available and supported by the user device 630, such as a touchscreen, keyboard, mouse, cursor-control device, touchscreen, microphone, digital camera, video recorder or camcorder. These devices may be used to enter information and interact with the software and other devices described herein.

System 600 may include one or more networks 640. In some examples, the network 640 may be one or more of a wireless network, a wired network or any combination of wireless network and wired network and may be configured to connect the user device 630, the server 660, the administrator processor 610, and database or data storage unit 650. For example, the network 640 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 640 may include, without limitation, telephone lines, fiber optics, IEEE Ethernet 902.3, a wide area network, a wireless personal area network, a LAN, or a global network such as the Internet. In addition, the network 640 may support an Internet network, a wireless communication network, a cellular network, or the like, or any combination thereof. The network 640 may further include one network, or any number of the exemplary types of networks mentioned above, operating as a stand-alone network or in cooperation with each other. The network 640 may utilize one or more protocols of one or more network elements to which they are communicatively coupled. The network 640 may translate to or from other protocols to one or more protocols of network devices. Although the network 640 is depicted as a single network, it should be appreciated that according to one or more examples, the network 640 may include a plurality of interconnected networks, such as, for example, the Internet, a service provider's network, a cable television network, corporate networks, such as credit card association networks, and home networks. The network 640 may further include, or be configured to create, one or more front channels, which may be publicly accessible and through which communications may be observable, and one or more secured back channels, which may not be publicly accessible and through which communications may not be observable.

System 600 may include a database or data storage unit 650. The database or data storage unit 650 may be one or more databases configured to store data, including without limitation, private data of users, financial accounts of users, identities of users, transactions of users, and certified and uncertified documents. The database or data storage unit 650 may include a relational database, a non-relational database, or other database implementations, and any combination thereof, including a plurality of relational databases and non-relational databases. In some examples, the database or data storage unit 650 may include a desktop database, a mobile database, or an in-memory database. Further, the database or data storage unit 650 may be hosted internally by the server 660 or may be hosted externally of the server 660, such as by a server, by a cloud-based platform, or in any storage device that is in data communication with the server 660.

The system can include a server 660. The server 660 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. The server may be a combination of one or more cloud computing systems such as public clouds, private clouds, and hybrid clouds.

The server 660 may include a processor 661, a memory 662, and an application 663. The processor 661 may be a processor, a microprocessor, or other processor, and the server 660 may include one or more of these processors. The processor 661 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 661 may be coupled to the memory 662. The memory 662 may be a read-only memory, write-once read-multiple memory or read/write memory, e.g., RAM, ROM, and EEPROM, and the server 660 may include one or more of these memories. A read-only memory may be factory programmable as read-only or one-time programmable. One-time programmability provides the opportunity to write once then read many times. A write-once read-multiple memory may be programmed at one point in time. Once the memory is programmed, it may not be rewritten, but it may be read many times. A read/write memory may be programmed and re-programed many times after leaving the factory. It may also be read many times. The memory 662 may be configured to store one or more software applications, such as the application 663, and other data, such as user's private data and financial account information.

The application 663 may include one or more software applications, such as a mobile application and a web browser, including instructions for execution on the server 660. In some examples, the server 660 may execute one or more applications, such as software applications, that enable, for example, network communications with one or more components of the system 600, transmit and/or receive data, and perform the functions described herein. Upon execution by the processor 661, the application 663 may provide the functions described in this specification, specifically to execute and perform the steps and functions in the process flows described below. Such processes may be implemented in software, such as software modules, for execution by computers or other machines. The application 663 may provide graphical user interfaces (GUIs) through which a user may view and interact with other components and devices within the system 600. The GUIs may be formatted, for example, as web pages in HyperText Markup Language (HTML), Extensible Markup Language (XML) or in any other suitable form for presentation on a display device depending upon applications used by users to interact with the system 600.

The server 660 may further include a display 664 and input devices 665. The display 664 may be any type of device for presenting visual information such as a computer monitor, a flat panel display, and a mobile device screen, including liquid crystal displays, light-emitting diode displays, plasma panels, and cathode ray tube displays. The input devices 665 may include any device for entering information into the server 660 that is available and supported by the server 660, such as a touchscreen, keyboard, mouse, cursor-control device, touchscreen, microphone, digital camera, video recorder or camcorder. These devices may be used to enter information and interact with the software and other devices described herein.

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features and advantages of the embodiments may be combined in any suitable manner. One skilled in the art will recognize that the embodiments may be practiced without one or more of the features or advantages of an embodiment, and one skilled in the art will recognize the features or advantages of an embodiment can be interchangeably combined with the features and advantages of any other embodiments. In other instances, additional features and advantages may be recognized in certain embodiments that may not be present in all embodiments.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above-described embodiments, method, and examples, but by all embodiments within the scope and spirit of the invention as claimed.

Further, it is to be understood that the terminology used herein is for the purpose of describing particular embodiments only and is not intended to be limiting. The terms “a” or “an” as used herein, are defined as one or more than one. The term “plurality” as used herein, is defined as two or more than two. The term “another” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper,” “lower,” “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

The preceding description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Although the embodiments describe quantum computing, a person of skill in the art recognizes that quantum computing leverages quantum particle principles and encompasses classical computing as a subset. It has a broader computational range due to superposition, entanglement, and inference. Classical computing relies on gate-based operations, which are also executable on the circuit level in quantum computing.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions executable by a computer hardware arrangement described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

What is claimed is:

1. A system comprising:
a quantum processor; and
a memory comprising instructions stored thereon, which, when executed by the quantum processor causes the system to perform operations comprising:
loading one or more variables and one or more probability distributions to a quantum system;
initiating a quantum walk on the one or more variables and the one or more probability distributions, wherein the quantum walk comprises one or more predetermined steps, wherein each predetermined step is associated with a quantum arithmetic operation on the one or more variables and the one or more probability distributions; and
determining, upon a last quantum arithmetic operation, a target variable by estimating a quantum state of the quantum system.

2. The system of claim 1, wherein the one or more probability distributions comprise at least one probability distribution selected from a group comprising a normal probability distribution, a log-normal probability distribution, a uniform probability distribution, or a constant probability distribution.

3. The system of claim 1, wherein the loading of the one or more variables and the one or more probability distributions comprises at least one or more sizes of the one or more probability distributions, one or more means of the one or more probability distributions, and one or more bounds of the one or more probability distributions.

4. The system of claim 1, wherein the operations further comprise:
defining a number of qubits for representing each of the one or more variables.

5. The system of claim 1, wherein the quantum arithmetic operations comprise at least one selected from a group comprising quantum addition, quantum multiplication, or quantum exponentiation.

6. The system of claim 1, wherein the one or more variables and the one or more probability distributions are loaded onto the quantum processor using one or more quantum gates and quantum registers.

7. The system of claim 1, wherein the quantum walk is performed with a variable number of predetermined steps.

8. The system of claim 1, wherein the operations further comprise:
transmitting the estimation of the target variable to a user device.

9. The system of claim 1, wherein, during the quantum walk, the quantum processor adjusts one or more quantum variables and probability distributions of the walk based on intermediate results of the quantum arithmetic.

10. A method for estimating a target outcome, the method comprising:
loading, by a quantum processor, one or more variables and one or more probability distributions into a quantum system;
initiating, by the quantum processor, a quantum walk on the one or more variables and probability distributions, wherein the quantum walk comprises one or more predetermined steps, wherein each predetermined step is associated with a quantum arithmetic operation on the one or more variables and the one or more probability distributions; and
determining, upon a last quantum arithmetic operation, a target variable by estimating a quantum state of the quantum system.

11. The method of claim 10, wherein the quantum estimation is a confidence interval for the estimated target variable.

12. The method of claim 10 further comprising storing, by the quantum processor, one or more results of the quantum arithmetic operations in a data storage unit.

13. The method of claim 10, wherein performing the quantum estimation of the target comprises evaluating an amplitude of the quantum state.

14. The method of claim 13 further comprising amplifying the amplitude of the quantum state.

15. The method of claim 14, wherein the quantum processor uses quantum amplitude estimation (QAE) to perform the quantum estimation.

16. The method of claim 10, wherein the target variable is portfolio of investments.

17. The method of claim 16, wherein the quantum walk is simulated based on a function comprising one or more of the quantum state, a number of paths of a random stochastic walk, a number of steps spanning a time interval from 0 to T, or a state in a register representing a change in the quantum walk at time t.

18. The method of claim 10, wherein the quantum walk is modeled after a Monte Carlo simulation.

19. The method of claim 10 further comprising repeating one or more previous steps.

20. A non-transitory computer readable medium containing computer executable instructions that, when executed by a computer hardware arrangement, cause the computer hardware arrangement to perform procedures comprising:
loading, by a quantum processor, one or more variables and one or more probability distributions into a quantum system;
initiating, by the quantum processor, a quantum walk on the one or more variables and distributions, wherein the quantum walk comprises one or more predetermined steps, wherein each predetermined step is associated with a quantum arithmetic operation on the one or more variables and probability distributions; and
determining, upon a last quantum arithmetic operation, a target variable by estimating a quantum state of the quantum system.
